(19) United States
(12) Patent Application Publication
(10) Pub. No.: US 2024/0137662 A1
(43) Pub. Date: Apr. 25, 2024

(54) IMAGE SYNCHRONIZATION SYSTEM FOR MULTIPLE CAMERAS AND METHOD THEREOF

(71) Applicant: INSTITUTE FOR INFORMATION INDUSTRY, Taipei City (TW)

(72) Inventors: YU-SHENG TSENG, TAIPEI CITY (TW); Daw-Tung LIN, TAIPEI CITY (TW); Matveichev Dmitrii, TAIPEI CITY (TW)

(73) Assignee: INSTITUTE FOR INFORMATION INDUSTRY, TAIPEI CITY (TW)

(21) Appl. No.: 17/988,836

(22) Filed: Nov. 17, 2022

(30) Foreign Application Priority Data
Oct. 19, 2022 (TW) 111139917

(51) Int. Cl. H04N 5/247; H04N 5/232; H04N 7/18

(52) U.S. Cl. CPC H04N 5/247; H04N 5/23218; H04N 5/23299; H04N 7/181

(57) ABSTRACT

An image synchronization method for multiple cameras, comprising the following steps: receiving a first video of a first camera and a second video of a second camera; capturing a first object in the first video and a second object in the second video; determining whether the first object is the same as the second object; if yes, transferring a first coordinate of the first object and a second coordinate of the second object to a uniform coordinate; regulating a timing sequence of the second video to calculate a plurality of multi-object tracking accuracy values for the second video and the first video and identifying a maximum multi-object tracking accuracy value; generating a time compensation value according to a time different corresponding to the maximum multi-object tracking accuracy value and synchronizing the first camera and the second camera according to the time compensation.

### CROSS-REFERENCE TO RELATED APPLICATIONS

This application claims the benefit of the filing date of Taiwan Patent Application No. 111139917, filed on Oct. 20, 2022, in the Taiwan Intellectual Property Office, the disclosure of which is incorporated herein in its entirety by reference and made a part of the specification.

### BACKGROUND OF THE INVENTION

### 1. Field of the Invention

The present invention relates to a camera video synchronizing system and a method thereof, in particular to an image synchronization system for multiple cameras and method thereof for shooting videos or broadcasting real time.

### 2. Description of the Related Art

A camera is a video shooting device. The camera is widely applied on shooting vehicle at a crossroad, broadcasting a sport event, and other situations. Regardless, multiple cameras are utilized to capture videos and cohered captured videos on a same video.

The traffic monitor system is used to detect, trace, and predict various vehicles. The traffic monitor system comprises multiple cameras, which are usually disposed at a crossroad. Take the crossroad as an example, since there are many people and vehicles at the crossroad, and the crossroad comprises four directions of East, West, South, and North, the multiple cameras are used to capture, compare, trace, and monitor people and vehicle at the crossroad. Because a hardware, a video capturing device, a compress software, an Internet bandwidth, network flows and other factors, each of the multiple cameras respectively captures videos may generate various problems that videos transferred to the back-end easy fail to be synchronized when the videos are proceeded with the image process. Furthermore, the following step for the trace and the accuracy of the video are affected.

Although camera video synchronizing technology has been developed, the related art is limited on the hardware to simultaneously transfer the video signal and calibrate the video signal. However, transferring the video signal via Internet may fail to synchronize the videos because of the Internet flow delay. Therefore, the accuracy for synchronizing the videos are affected. Alternatively, transferring the video signal via the private line is easy affected because of the disposition and distance of the physical line. Hence, the cost for construction is raised.

As mentioned above, take a synchronizing control module and a synchronizing timing sequence module as examples, the video signal is easy to be affected via Internet or the private line to transfer because of the external environment. Therefore, the two modules fail to synchronize the video signal real time because of the delayed factor. In addition, for the synchronizing control module, since the synchronizing control module is adapted to synchronize two cameras, it fails to be widely applied on synchronizing the multiple cameras.

Accordingly, how to provide an image synchronization system for multiple cameras and method thereof to solve the problems mentioned above is an urgent subject to tackle.

### SUMMARY OF THE INVENTION

In view of this, the present invention provides an image synchronization method for multiple cameras, performing following steps by a processor: receiving a first video captured by a first camera and a second video captured by a second camera; wherein the first video comprises a plurality of first frames, the second video comprises a plurality of second frames, and the plurality of first frames comprises a first predetermined frame; capturing a first object in the first video and a second object in the second video; determining whether the first object in the first video is the same as the second object in the second video; when the first object in the first video is the same as the second object in the second video, the processor transfers a plurality of first positions in a first coordinate of the first object in the first video to a plurality of first uniform positions in a uniform coordinate and transferring a plurality of second positions in a second coordinate of the second object in the second video to a plurality of second uniform positions in the uniform coordinate, wherein at least a part of the first uniform position overlaps with the second uniform position; regulating a timing sequence of the second video to calculate a plurality of first multi-object tracking accuracy values for the first video and the second video and identifying a maximum multi-object tracking accuracy value according to the plurality of first multi-object tracking accuracy values; generating a time compensation value according to a first time different corresponding to the maximum multi-object tracking accuracy value; and synchronizing the first video of the first camera and the second video of the second camera according to the time compensation value.

The present invention further provides an image synchronization system for multiple cameras, comprising a first camera, a second camera, and a processor. The first camera is configured to capture a first video; wherein the first video comprises a plurality of first frames. The second camera is configured to capture a second video; wherein the second video comprises a plurality of second frames. The processor is connected to the first camera and the second camera and configured to receive the first video and the second video; wherein the plurality of first frames comprise a first predetermined frame; capture a first object in the first video and capturing a second object in the second video; determine whether the first object in the first video is the same as the second object in the second video; when the first object in the first video is the same as the second object in the second video, the processor transfers a plurality of first positions in a first coordinate of the first object in the first video to a plurality of first uniform positions in a uniform coordinate and transfers a plurality of second positions in a second coordinate of the second object in the second video to a plurality of second uniform positions in the uniform coordinate; wherein at least a part of the first uniform positions overlap with a part of the second uniform positions; regulate a timing sequence of the second video to calculate a plurality of first multi-object tracking accuracy values for the first video and the second video and identify a maximum multi-object tracking accuracy value according to the plurality of first multi-object tracking accuracy values; generate a time compensation value according to a first time different corresponding to the maximum multi-object tracking accuracy value; and synchronize the first video of the first camera and the second video of the second camera according to the time compensation value.

As mentioned above, the present invention image synchronization system for multiple cameras and method thereof is capable of synchronizing and cooperating multiple cameras real time, mapping the GPS coordinate of object such as vehicle in the frame of the video of the multiple cameras to the real world, and providing users decisions and judgements according to more stable data. Moreover, the present invention has the effects of synchronizing shooting surrounds, synchronizing live broadcasts real time, and connecting frames continuously without delay via synchronizing videos of multiple cameras. Therefore, the present invention can be widely applied on monitors of a crossroad and broadcasts of a sport event. In addition, the image synchronization system for multiple cameras and method thereof of the present invention is capable of predicting the moving trace, the traffic accident, and the object behavior. In addition, the present invention is widely applied on checking whether frames are loss at specific time interval in the multiple cameras. Furthermore, the present invention synchronizes videos based on the software without an extra hardware so that avoiding the external environment resulting in Internet delay and failing to synchronize videos real time.

### BRIEF DESCRIPTION OF THE DRAWINGS

FIG. 1 is the flowchart of the image synchronization method for multiple cameras for multiple cameras of the present invention;

FIG. 2 is the schematic diagram used the three dimension bounding box to indicate the object;

FIG. 3A is the schematic diagram that the camera captures the video at a crossroads;

FIG. 3B is the video schematic diagram that the coordinate of the crossroads is transformed;

FIG. 4A to FIG. 4D are the video schematic diagrams captured by distinct cameras disposed at the same crossroads;

FIG. 4E to FIG. 4H are the schematic diagrams that FIG. 4A to FIG. 4D are respectively transformed by the GPS homography transformation;

FIG. 4I is the schematic diagram of the overlapped region in FIG. 4E to FIG. 4H;

FIG. 5 is the flowchart for calculating the multi-object tracking accuracy value of the present invention;

FIG. 6 is the time curve and warping time curve schematic diagram for transforming the frame of the first camera and the frame of the second camera; and

FIG. 7 is the block diagram of image synchronization system for multiple cameras of the present invention.

### DETAILED DESCRIPTION OF THE INVENTION

The image synchronization method for multiple cameras of the invention is utilized to synchronize videos of multiple cameras. The videos captured by each one of the cameras respectively comprise a plurality of frames. That is, the video is composed of a plurality of frames and an object may exist in the plurality of frames. For convenient to illustrate, the embodiments in the invention take a vehicle as the object. For synchronizing the videos of the multiple cameras, a same object captured by the multiple cameras is utilized as basis to synchronize the videos. Therefore, the method first detects, compares, and recognizes the objects in the videos captured by the cameras. In addition, the synchronizations for the multiple cameras are divided into an initial state synchronization and an enabled state synchronization. The initial state synchronization is that the multiple cameras are synchronized at the initial state. The enabled state synchronization is that the multiple cameras are synchronized after the multiple cameras are enabled for a period. In following descriptions, the application first illustrates the embodiments that the method synchronizes the multiple cameras at the initial state.

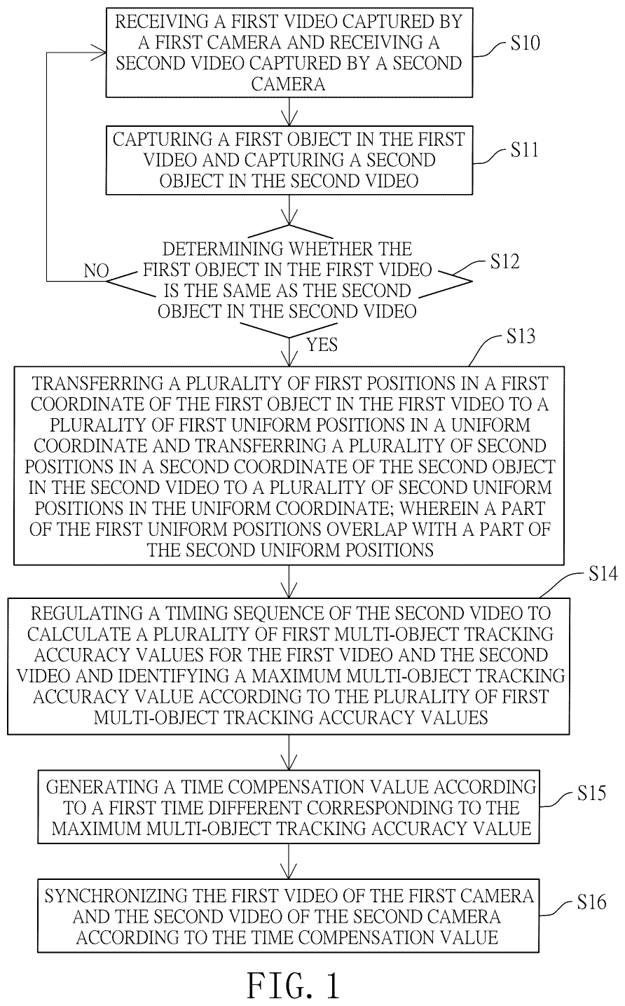

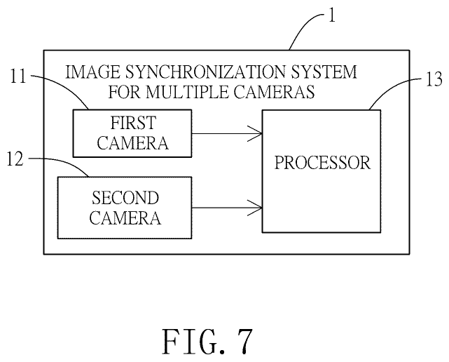

Refer to FIG. 1 and FIG. 7. FIG. 1 and FIG. 7 are the flowcharts of the image synchronization method for multiple cameras and the block diagram of the image synchronization system for multiple cameras of the present invention. The image synchronization system for multiple cameras 1 comprises a first camera 11, a second camera 12, and a processor 13. The processor 13 is connected to the first camera 11 and the second camera 12 with a wireless technology or a wire technology and performs steps S10˜S16.

In step S10, the processor 13 receives videos captured by each camera, comprising receiving a first video captured by the first camera 11 and receiving a second video captured by the second camera 12. In step S11, the processor 13 captures the first object in the first video and captures the second object in the second video.

In step S12, the processor 13 recognizes and detects the object by various video recognizing method. In an embodiment of the present invention, the object is recognized and detected by a YOLO (You Only Look Once; YOLO) neural networks module which has been trained. Since the video recognition technology of the YOLO neural networks module is adapted to recognize an object by a single camera but not adapted to recognize the same object between different cameras. Consequently, in step S12 for determining whether the first object in the first video is the same as the second object in the second video, the processor 13 indicates a size of a target object according to a location of each object via a two-dimensional boundary box. The processor 13 utilizes an image algorithm to recognize a first object two-dimensional boundary of the first object in the first video and recognize a second object two-dimensional boundary of the second object in the second video. In addition, if the processor 13 recognizes that the first object in the first video of the first camera is different with the second object in the second video of the second camera, the method returns to step S10 to receive the first video and the second video.

The size and centric position of the target object in the video indicated via the two-dimensional boundary is utilized to calculate the coordinate in next step. However, angles of a same object captured by different cameras are both different and the centric positions of the object in the videos indicated by the two-dimensional boundary are distinct and imprecise. For instance, when the camera captures the object at a side, whether the centric position of the object indicated by the two-dimensional boundary is located at the center point of the two-dimensional boundary is uncertain. Therefore, the method for indicating the two-dimensional boundary on the object fails to accurately synchronize the object in next steps to trace the object since the centric position of the object is inaccurate.

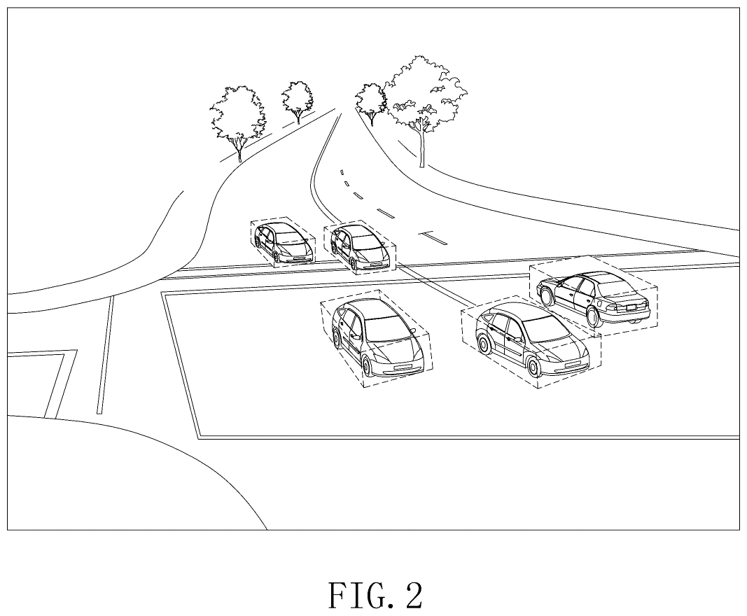

Refer to FIG. 2. FIG. 2 is the schematic diagram used the three dimension bounding box to indicate the object. As shown in FIG. 2, after indicating the size and centric position of the target object in the video via the two-dimensional boundary, the processor 13 calculates a first object bottom center coordinate of the first object in three-dimensional space according to the first object two-dimensional boundary and calculates a second object bottom center coordinate of the second object in three-dimensional space according to a second object two-dimensional boundary. After that, the processor 13 uses the three Dimension Bounding Box to indicate the bottom center coordinate of the target object in the video and aligns the bottom center coordinate of the same object in the video captured by different cameras. Hence, the error in next steps for transforming the coordinate can be diminished. Moreover, after the processor indicates the bottom center coordinate of the target object in the video via the three dimension bounding box, the bottom center coordinate of the target object is further mapped to the bottom center coordinate of the object in the video captured by other camera.

After receiving the bottom center coordinate of the object and by the video recognizing method, the processor 13 determines whether the first object in the first video captured by the first camera is the same as the second object in the second video captured by the second camera. The video recognizing method is used to capture various features of the object in the video. The features of the object comprise a color and a curve object and so on. When the method recognizes that the first object in the first video is the same as the second object in the second video, the method assigns an identification (ID) number to the object. Furthermore, the method records the time point and coordinate of the object appearing in different frames in the distinct videos, which are a coordinate trace of the object.

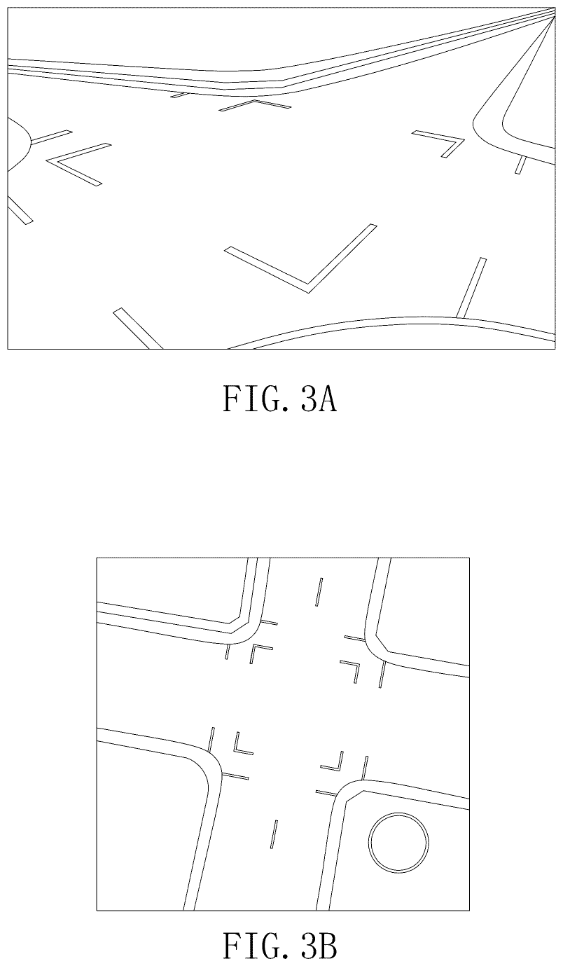

Refer to the example in FIG. 3A and FIG. 3B. FIG. 3A is the schematic diagram that the camera captures the video at a crossroads. FIG. 3B is the video schematic diagram that the coordinate of the crossroads is transformed. Since the distinct cameras comprise different coordinate systems and the distinct cameras are disposed at different angles and positions so that the positions of the same object displaying in the different coordinate systems are distinct. For the same object, the distinct coordinates of the same object between the distinct cameras can be transformed and combined via at least a part of overlapped regions in the video. Consequently, in step S13, the processor 13 calculates, transforms and maps the distinct coordinates in the different cameras to the uniform coordinate, such as Global Positioning System (GPS) coordinate. In the embodiment of the present invention, the processor 13 calculates, transforms and maps the distinct coordinates in the different cameras via a GPS homography transformation in step S13.

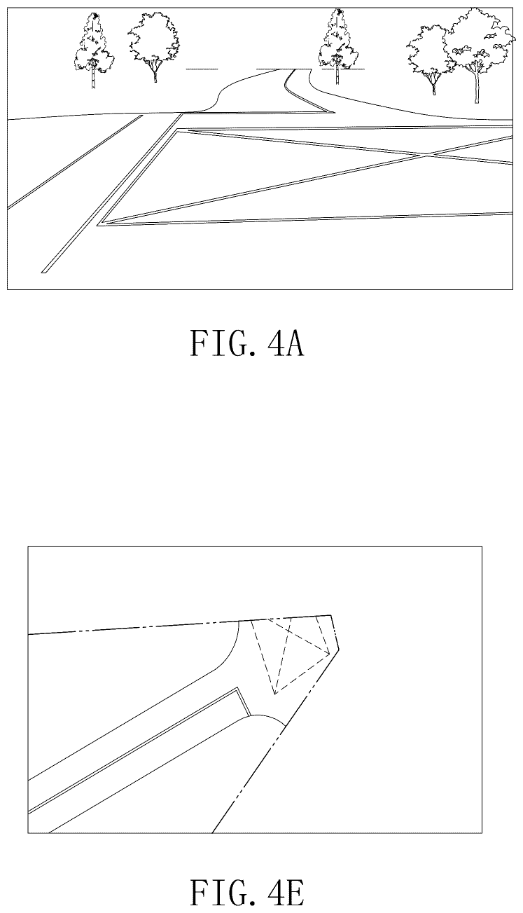

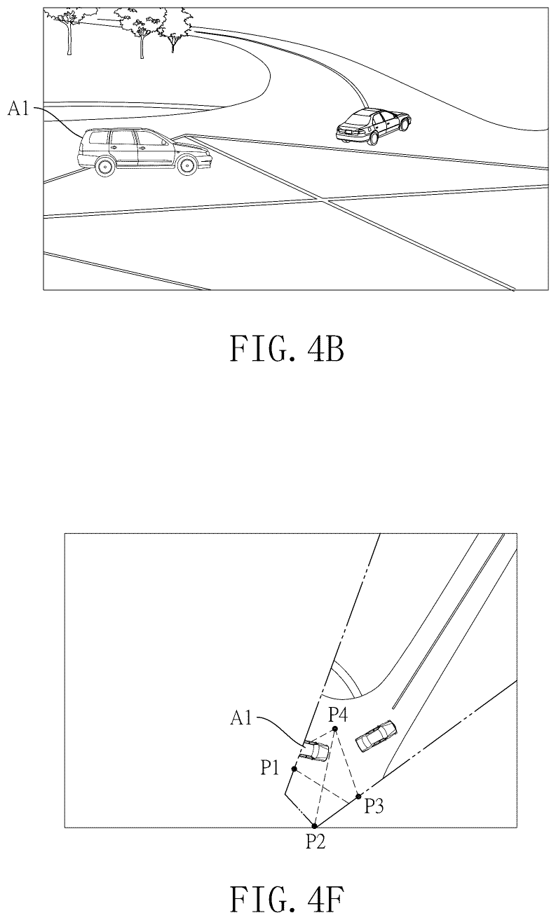

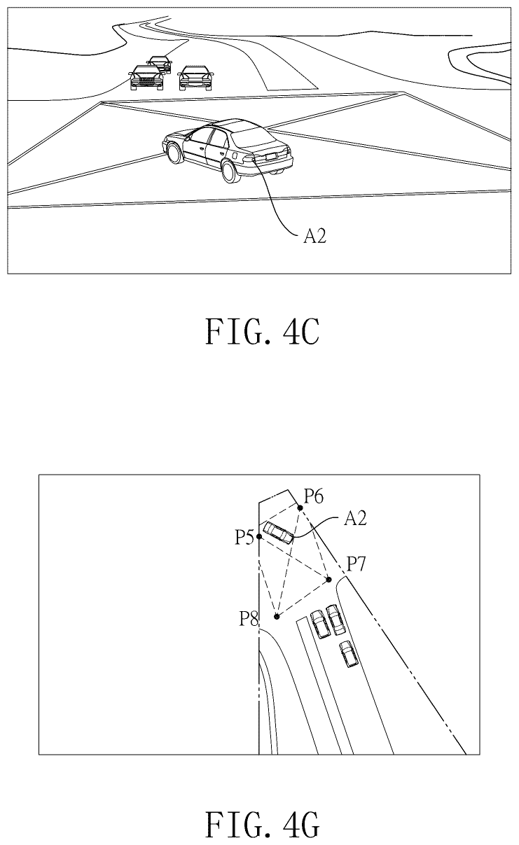

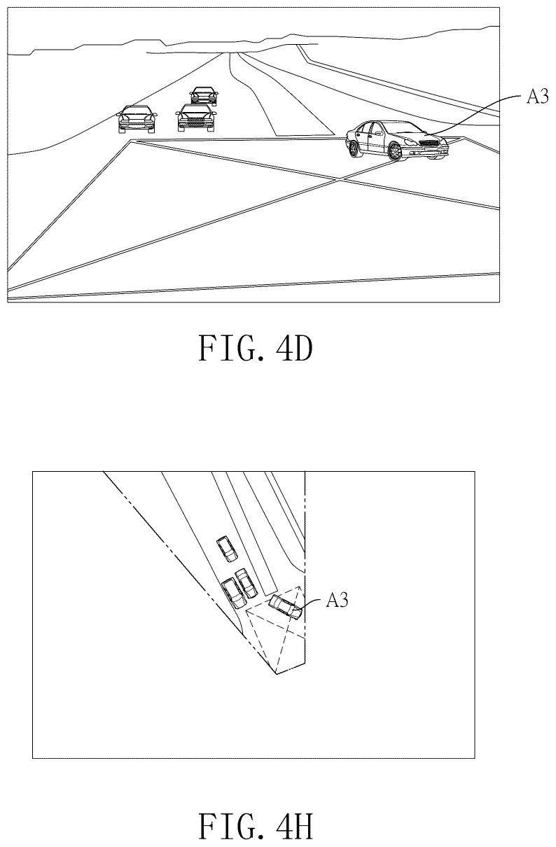

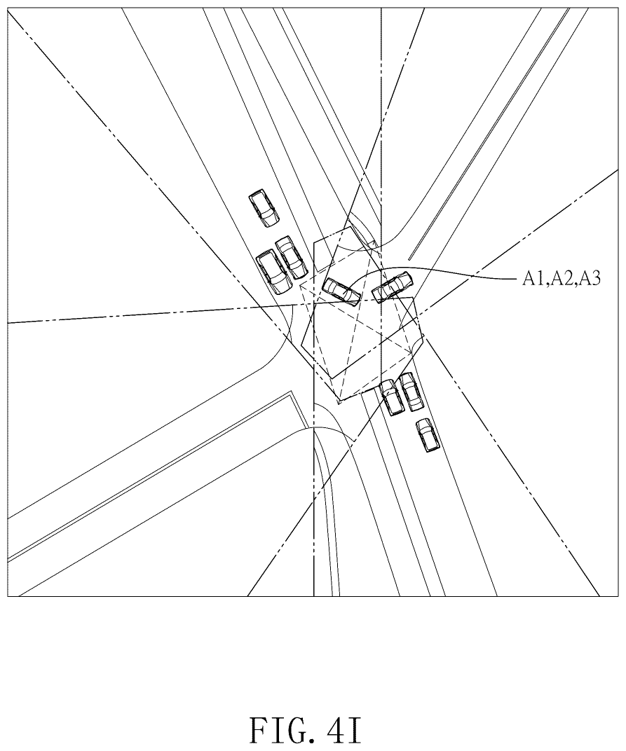

Refer to FIG. 4A to FIG. 4H. FIG. 4A to FIG. 4D are the video schematic diagrams captured by distinct cameras disposed at the same crossroads. FIG. 4E to FIG. 4H are the schematic diagrams that FIG. 4A to FIG. 4D are respectively transformed by the GPS homography transformation, wherein the transformed videos comprise a part of overlapped crossroads in the video. For convenient to illustrate, FIG. 4A and FIG. 4E corresponding to FIG. 4A are disposed at the same page and so on. As mentioned above, Since the same object captured by the distinct cameras has different coordinates, the step of GPS homography transformation first respectively defines a GPS coordinate in the frames of FIG. 4A to FIG. 4D.

In details, each camera utilizes the algorithm to project the video, transforms a plurality of first positions in the first coordinate of the first object in the first video to a plurality of first uniform positions in the GPS coordinate, and transforms a plurality of second positions in the second coordinate of the second object in the second video to a plurality of second uniform positions in the GPS coordinate. After that, the transformed GPS coordinates of each videos can be obtained.

In addition, the processor 13 finds the uniform GPS coordinate according to the GPS coordinates in the frames of FIG. 4E to FIG. 4H. That is, the processor 13 searches out at least a part of overlapped regions in each frames. Take FIG. 4F and FIG. 4G as an example, the processor 13 receives four coordinate positions P1, P2, P3, P4 in the overlapped regions in FIG. 4F and receives four coordinate positions P5, P6, P7, P8 in the overlapped regions in FIG. 4G. In fact, in the embodiment, the overlapped region is formed by four frames. Furthermore, since the first vehicle A1 in FIG. 4B, the second vehicle A2 in FIG. 4C and the third vehicle A3 in FIG. 4D are the same vehicle with the same ID, the processor 13 defines a plurality of GPS coordinates in FIG. 4F according to a plurality of coordinate traces of the first vehicle A1 in FIG. 4B, defines a plurality of GPS coordinates in FIG. 4G according to a plurality of coordinate traces of the second vehicle A2 in FIG. 4C, and defines a plurality of GPS coordinates in FIG. 4H according to a plurality of coordinate traces of the third vehicle A3 in FIG. 4D. For clearly to illustrate, it should be noted that each object (vehicle) in the figure displays only a position.

Refer to FIG. 4I. FIG. 4I is the schematic diagram of the overlapped region in FIG. 4E to FIG. 4H. As shown in the figure, the processor 13 projects, overlaps, and averages the GPS coordinate of the first vehicle A1, the second vehicle A2, and the third vehicle A3 to calculate the coordinate of the vehicle. The aforementioned steps are used to calibrate the coordinate of the object in space. However, each camera may generate a problem of time delay so that the coordinate of the object generates variations. Therefore, the method proceeds the following steps to synchronize a timing sequence of each camera. The method for synchronizing the timing sequence of each camera is to calculate a value of a multi-object tracking accuracy (MOTA) in step S14 and seeks a maximum multi-object tracking accuracy value corresponding to a time different to synchronize the timing sequence. The formula of the multi-object tracking accuracy value is described as below:

$$MOTA = 1 - \frac{{\sum }_{t} {FN}_{t} + {FP}_{t} + {IDS}_{r}}{{\sum }_{t} {GT}_{t}}$$

wherein MOTA represents the multi-object tracking accuracy value, FNₜ represents False Negative, FPₜ represents False Positive, IDSₜ represents ID Switch, and GTₜ represents ground truth.

To calculate the multi-object tracking accuracy value, step S14 is capable to calculating a tracking accuracy between each videos. In other words, step S14 gathers trace errors of the object in each videos via calculating amounts, traces, ID, and relative attributes of the object.

In details, the present invention applies the method for calculating the multi-object tracking accuracy value to the different videos captured by the distinct cameras and respectively captures and calculates the first video of the first camera 11 and the second video of the second camera 12. The method captures a first predetermined frame of the first camera 11 as a ground truth (GTₜ), which is an initial frame of the first video, that is, a first frame when the first camera 11 is at an initial state. Furthermore, the method creates a relation between the first predetermined frame of the first camera 11 and the second video of the second camera 12 to calculate first multi-object tracking accuracy values. In another embodiment, the first predetermined frame can be set as other frame at other time point in the first video, the present invention is not limited thereto.

The processor 13 further respectively captures and calculates the second video of the second camera 12 and the first video of the first camera 11. The method captures a second predetermined frame of the second camera 12 as a ground truth (GTₜ), which is an initial frame of the second video, that is, a first frame when the second camera 12 is at an initial state. Furthermore, the method creates a relation between the second predetermined frame of the second camera 12 and the first video of the first camera 11 to calculate second multi-object tracking accuracy values. In another embodiment, the second predetermined frame can be set as other frame at other time point in the second video, the present invention is not limited thereto.

For FNₜ, if all frames in the second video fail to match the same first object in the first predetermined frame, that is, the first object is missed and then FNₜ adds one. For FPₜ, if the IDs of distinct objects are matched to the same ID, FPₜ adds one. For example, if the first object and the second object are not the same object, the ID of the first object is assigned to 1 and the ID of the second object is assigned to 2, that is, distinct objects should be assigned different ID. However, if the distinct objects are assigned to the same ID 3 and then FPₜ adds one. For IDSₜ, if the first object and the second object are the same object, the ID of the first object is assigned to 1, the ID of the second object is assigned to 1. However, if the first object and the second object are the same object, the ID of the first object is assigned to 1, the ID of the second object is assigned to 2, and then IDSₜ adds one. Accordingly, an approximation for distinct videos is determined by the multi-object tracking accuracy value, that is, the greater the multi-object tracking accuracy value, the higher the approximation for the first video and the second video.

As mentioned above, after step S15 determines the maximum multi-object tracking accuracy value, the frame with the most approximation is determined. At the meanwhile, the processor 13 calculates the time compensation value according to a difference between the frames and synchronizes the first video of the first camera 11 and the second video of the second camera 12 according to the time compensation value in step S16. For instance, in step S14, step S14 regulates the timing sequence of the second video to change the initial frame of the video and calculates two videos with the most approximation corresponding to the maximum multi-object tracking accuracy value, wherein the first video uses the first frame as the initial frame of the video and the second video uses the sixth frame as the initial frame of the video. Accordingly, the processor 13 calculates the difference of five frames between the first video captured by the first camera 11 and the second video captured by the second camera 12, that is, the difference of the five frames is the time compensation value. The processor synchronizes the sixth frame of the second camera 12 to the first frame of the first camera 11 according to the time compensation value so that the first camera 11 and second camera 12 are synchronized. Accordingly, the videos of the multiple cameras are synchronized at the initial state.

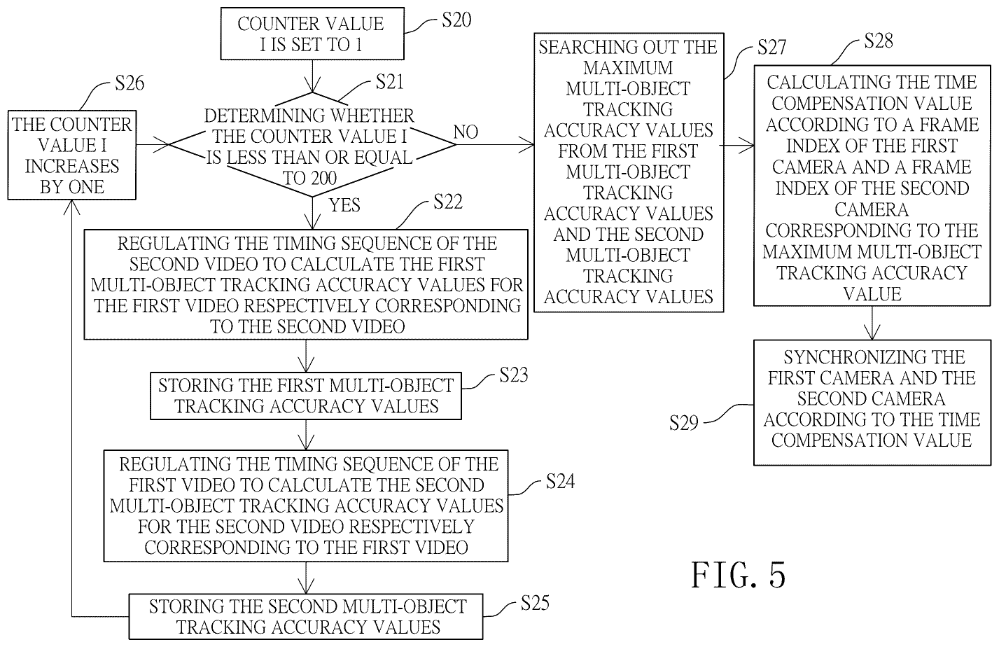

Refer to FIG. 5. FIG. 5 is the flowchart for calculating the multi-object tracking accuracy value of the present invention. In the embodiment, the flowchart calculates and compares two hundred frames and repeats the steps to 200th frame. In step S20, the counter value i is set to 1. In step S21, the processor 13 determines whether the counter value i is less than or equal to 200. In details, before step S20, the processor 13 captures the first video captured by the first camera 11 and the second video captured by the second camera 12 at the initial state. The first video and the second video respectively comprise 200 continuous frames. It should be noted that 200 frames are an example, the present invention is not limited thereto.

If the counter value I is less than or equal to 200, in step S22, step S22 regulates the timing sequence of the second video to calculate the first multi-object tracking accuracy values for the first video respectively corresponding to the second video. The first multi-object tracking accuracy values are represented by the symbol MOTA(Camera_1_f1, Camera_2_fi), wherein Camera_1_f1 represents that the initial frame of the first video is the first frame and Camera_2_fi represents that the initial frame of the second video is the Ith frame. Accordingly, by fixing the initial frame of the first video as the first frame, the processor 13 regulates the initial frame of the second video from the first frame to the 200th frame and calculates the overlapped frame in the timing sequence of the first video and the second video. Hence, a plurality of first multi-object tracking accuracy values can be obtained.

In step S23, step S23 stores the first multi-object tracking accuracy values.

In step S24, step S24 regulates the timing sequence of the first video to calculate the second multi-object tracking accuracy values for the second video respectively corresponding to the first video. The second multi-object tracking accuracy values are represented by the symbol MOTA(Camera_1_fi, Camera_2_f1), wherein Camera_1_fi represents that the initial frame of the first video is the Ith frame and Camera_2_f1 represents that the initial frame of the second video is the first frame. Accordingly, by fixing the initial frame of the second video as the first frame, the processor 13 regulates the initial frame of the first video from the first frame to the 200th frame and calculates the overlapped frame in the timing sequence of the first video and the second video. Hence, a plurality of second multi-object tracking accuracy values can be obtained.

In step S25 step S25 stores the second multi-object tracking accuracy values.

In step S26, the counter value i increases by one and step S26 returns to step S21. If the counter value I is more than 200, the processor 13 searches out the maximum multi-object tracking accuracy values from the first multi-object tracking accuracy values and the second multi-object tracking accuracy values in step S27. In step S28, the processor 13 calculates the time compensation value according to a frame index of the first camera 11 and a frame index of the second camera 12 corresponding to the maximum multi-object tracking accuracy value. The frame index of the first camera 11 and the frame index of the second camera 12 are the difference between the first video and the second video. For example, if maximum multi-object tracking accuracy value is founded when comparing the 1st frame of the first video of the first camera 11 and the 9th frame of the second video of the second camera 12, then the time compensation value will be 8 frames by calculating the time difference between the 1st frame of the first video and the 9th frame of the second video through the processor 13. In step S29, the processor 13 synchronizes the first camera 11 and the second camera 12 according to the time compensation value.

It should be noted that the either step S22 or step S24 can be executed, or both step S22 and step S24 can be executed. The present invention is not limited thereto.

Aforementioned steps synchronize the cameras at the initial state according to the time compensation value. However, after the cameras are enabled, each camera may fail to be synchronized over time. Consequently, the following steps further calibrate the timing sequence of the multiple cameras by secondly synchronizing the multiple cameras. After the initial state, the processor 13 synchronizes the first video of the first camera 11 and the second video of the second camera 12 according to an offset compensation value by a dynamic time warping algorithm.

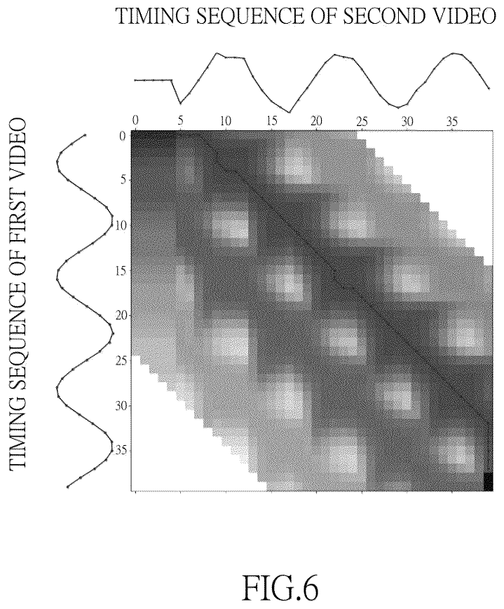

Refer to table 1, table 2, and FIG. 6. Table 1 is the frame sequence of the first video of the first camera 11. Table 2 is the frame sequence of the second video of the second camera 12. FIG. 6 is the time curve and warping time curve schematic diagram for transforming the frame of the first camera 11 and the frame of the second camera 12. In the embodiment, the present invention applies the dynamic time warping algorithm to dynamically synchronize the synchronized camera videos to solve Internet, an video processing, and an external environment resulting in delay problems. The dynamic time warping algorithm utilizes one of the camera videos as a reference value and another camera videos as a test value. After the dynamic time warping algorithm compares accumulative distance differences between the time curves of the two camera videos to obtain a minimum group, regulating a time different.

TABLE 1
first camera 11

| frame | 1 | 2 | 3 | 4 | 5 | . . . | 198 | 199 | 200 |
|---|---|---|---|---|---|---|---|---|---|
| data | No. 1 | No. 1 | No. 1 | No. 1 | No. 1 | . . . | No. 1 | No. 1 | No. 1 |
| | X1 | X2 | X3 | X4 | X5 | | X198 | X199 | X200 |

TABLE 2
second camera 12

| frame | 1 | 2 | 3 | 4 | 5 | . . . | 198 | 199 | 200 |
|---|---|---|---|---|---|---|---|---|---|
| data | No. 2 | No. 2 | No. 2 | No. 2 | No. 2 | . . . | No. 2 | No. 2 | No. 2 |
| | Y1 | Y2 | Y3 | Y4 | Y5 | | Y198 | Y199 | Y200 |

As shown in FIG. 6, take X axis in two-dimensional space as an example. The dynamic time warping algorithm projects an first object moving trace and a second object moving trace together to compare the approximation of the two moving traces, wherein the first object moving trace is the moving trace of the first object of the first video on the X axis in two-dimensional space and the second object moving trace is the moving trace of the second object of the second video on the X axis in two-dimensional space. In addition, the first object moving trace comprises aforementioned frame sequence of the first camera 11 in Table 1 and the second object moving trace comprises aforementioned frame sequence of the second camera 12 in Table 2. Furthermore, the dynamic time warping algorithm calculates the difference of the projected moving traces. For instance, after the dynamic time warping algorithm projects the first object moving trace and the second object moving trace together and compares the difference and the variation between the segments of the two moving traces, extending or shortening the frame sequences of the two videos to obtain the shortest and the most approximation frame sequences. That is, the shortest frame sequence is the offset compensation value between the frame sequences of the first video and the second video. The processor 13 according to the offset compensation value shifts the frames of the first camera 11 or shifts the frames of the second camera 12 to synchronize the first video of the first camera 11 and the second video of the second camera 12.

The principle to determine the shortest and the most approximation of the two frame sequences is described as below. As shown in Table 1 and Table 2, if the feature data X1 of the first frame in the first object video of the first camera 11 is most approximate to the feature data Y5 of the second frame in the second object video of the second camera 12, the processor 13 determines that the shortest frame sequence between the first video and the second video is four frames, which is the offset compensation value. The processor 13 curtails four frames of the second video via the dynamic time warping algorithm so that the first frame of the first video aligns to the first frame to the fifth frame of the second video. Accordingly, the present invention completes the synchronizing for first video of the first camera 11 and the second video of second camera 12.

In summary, the present invention image synchronization system for multiple cameras and method thereof is capable of synchronizing and cooperating multiple cameras real time, mapping the GPS coordinate of object such as vehicle in the frame of the video of the multiple cameras to the real world, and providing users decisions and judgements according to more stable data. Moreover, the present invention has the effects of synchronizing shooting surrounds, synchronizing live broadcasts real time, and connecting frames continuously without delay via synchronizing videos of multiple cameras. Therefore, the present invention can be widely applied on monitors of a crossroad and broadcasts of a sport event. In addition, the image synchronization system for multiple cameras and method thereof of the present invention is capable of predicting the moving trace, the traffic accident, and the object behavior. In addition, the present invention is widely applied on checking whether frames are loss at specific time interval in the multiple cameras. Furthermore, the present invention synchronizes videos based on the software without an extra hardware so that avoiding the external environment resulting in Internet delay and failing to synchronize videos real time.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. An image synchronization method for multiple cameras, performing following steps by a processor:
receiving a first video captured by a first camera and a second video captured by a second camera; wherein the first video comprises a plurality of first frames and the second video comprises a plurality of second frames;
capturing a first object in the first video, and capturing a second object in the second video;
determining whether the first object in the first video is the same as the second object in the second video;
when the first object in the first video is the same as the second object in the second video, transforming a plurality of first positions in a first coordinate of the first object in the first video to a plurality of first uniform positions in a uniform coordinate, and transferring a plurality of second positions in a second coordinate of the second object in the second video to a plurality of second uniform positions in the uniform coordinate, wherein a part of the first uniform positions overlaps with a part of the second uniform positions;
regulating a timing sequence of the second video to calculate a plurality of first multi-object tracking accuracy values between the first video and the second video and identifying a maximum multi-object tracking accuracy value according to the plurality of first multi-object tracking accuracy values;
generating a time compensation value according to a first time different corresponding to the maximum multi-object tracking accuracy value; and
synchronizing the first video of the first camera and the second video of the second camera according to the time compensation value.

2. The image synchronization method for multiple cameras as claimed in claim 1, wherein the plurality of first frames comprises a first predetermined frame, and the first predetermined frame corresponds to a first initial time point in the first video.

3. The image synchronization method for multiple cameras as claimed in claim 2, wherein the second video comprises a second predetermined frame, and the second predetermined frame corresponds to a second initial time point in the second video.

4. The image synchronization method for multiple cameras as claimed in claim 1, wherein the processor utilizes an image algorithm to recognize a first object two-dimensional boundary of the first object in the first video, and to recognize a second object two-dimensional boundary of the second object in the second video.

5. The image synchronization method for multiple cameras as claimed in claim 4, wherein the processor calculates a first object bottom center coordinate of the first object in a three-dimensional space according to the first object two-dimensional boundary, and calculates a second object bottom center coordinate of the second object in a three-dimensional space according to the second object two-dimensional boundary.

6. The image synchronization method for multiple cameras as claimed in claim 3, wherein the processor further regulates a timing sequence of the first video to calculate a plurality of second multi-object tracking accuracy values between the second video and the first video and identifies the maximum multi-object tracking accuracy value according to the first multi-object tracking accuracy values and the second multi-object tracking accuracy values.

7. The image synchronization method for multiple cameras as claimed in claim 1, wherein the first camera and the second camera are respectively at an initial state.

8. The image synchronization method for multiple cameras as claimed in claim 7, after the first video of the first camera and the second video of the second camera are synchronized according to the time compensation value, the processor further synchronizes the first video of the first camera and the second video of the second camera according to an offset compensation value.

9. The image synchronization method for multiple cameras as claimed in claim 8, wherein the processor synchronizes the first video of the first camera and the second video of the second camera by a dynamic time warping algorithm according to the offset compensation value.

10. An image synchronization system for multiple cameras, comprising:
a first camera, being configured to capture a first video; wherein the first video comprises a plurality of first frames;
a second camera, being configured to capture a second video; wherein the second video comprises a plurality of second frames; and
a processor, connected to the first camera and the second camera, and being configured to:
receive the first video and the second video;
capture a first object in the first video, and capturing a second object in the second video;
determine whether the first object in the first video is the same as the second object in the second video;
when the first object in the first video is the same as the second object in the second video, transfer a plurality of first positions in a first coordinate of the first object in the first video to a plurality of first uniform positions in a uniform coordinate, and transfer a plurality of second positions in a second coordinate of the second object in the second video to a plurality of second uniform positions in the uniform coordinate, wherein a part of the first uniform positions overlaps with a part of the second uniform position;
regulate a timing sequence of the second video to calculate a plurality of first multi-object tracking accuracy values between the first video and the second video and identifying a maximum multi-object tracking accuracy value according to the plurality of first multi-object tracking accuracy values;
generate a time compensation value according to a first time different corresponding to the maximum multi-object tracking accuracy value; and
synchronize the first video of the first camera and the second video of the second camera according to the time compensation value.

11. The image synchronization system for multiple cameras as claimed in claim 10, wherein the first video comprises a first predetermined frame, and the first predetermined frame corresponds a first initial time point in the first video.

12. The image synchronization system for multiple cameras as claimed in claim 11, wherein the second video comprises a second predetermined frame, and the second predetermined frame corresponds to a second initial time point in the second video.

13. The image synchronization system for multiple cameras as claimed in claim 10, wherein the processor utilizes an image algorithm to recognize a first object two-dimensional boundary of the first object in the first video, and to recognize a second object two-dimensional boundary of the second object in the second video.

14. The image synchronization system for multiple cameras as claimed in claim 13, wherein the processor calculates a first object bottom center coordinate of the first object in a three-dimensional space according to the first object two-dimensional boundary and calculates a second object bottom center coordinate of the second object in a three-dimensional space according to the second object two-dimensional boundary.

15. The image synchronization system for multiple cameras as claimed in claim 12, wherein the processor further regulates a timing sequence of the first video to calculate a plurality of second multi-object tracking accuracy values between the second video and the first video and identifies the maximum multi-object tracking accuracy value according to the first multi-object tracking accuracy values and the second multi-object tracking accuracy values.

16. The image synchronization system for multiple cameras as claimed in claim 10, wherein the first camera and the second camera are respectively at an initial state.

17. The image synchronization system for multiple cameras as claimed in claim 16, after the first video of the first camera and the second video of the second camera are synchronized according to the time compensation value, the processor further synchronizes the first video of the first camera and the second video of the second camera according to an offset compensation value.

18. The image synchronization system for multiple cameras as claimed in claim 17, wherein the processor synchronizes the first video of the first camera and the second video of the second camera by a dynamic time warping algorithm according to the offset compensation value.
